(19) United States
(12) Patent Application Publication
(10) Pub. No.: US 2005/0010908 A1
(43) Pub. Date: Jan. 13, 2005

(54) Method, apparatus and computer program product for implementing breakpoint based performance measurement

(75) Inventors: Mark Robert Funk, Mantorville, MN (US); Michael James Denney, Rochester, MN (US)

Correspondence Address: Grant A. Johnson;IBM Corporation - Dept. 917, 3605 Highway 52 North, Rochester, MN, 55901, US

(73) Assignee: INTERNATIONAL BUSINESS MACHINES CORPORATION, ARMONK, NY (US)

(21) Appl. No.: 10/616,525

(22) Filed: Jul. 10, 2003

(51) Int. Cl. G06F 9/44

(52) U.S. Cl. 717/124; 712/220

(57) ABSTRACT

A method, apparatus and computer program product are provided for implementing breakpoint based performance measurement. A set of hardware counters is defined for counting user specified hardware events. The hardware counters are programmable for counting predefined processor events and the predefined processor events include processor cycles. A start breakpoint instruction and a stop breakpoint instruction are inserted in hardware instructions. The hardware instructions are executed and processing of the hardware instructions is suspended responsive to executing the start breakpoint instruction. Responsive to executing the start breakpoint instruction, interrupt handler instructions are entered and breakpoint instructions are called. The breakpoint instructions generating a return from interrupt instruction to start the defined set of hardware counters and to return processing from the interrupt handler instructions to the hardware instructions. Then executing the hardware instructions is suspended responsive to executing the end breakpoint instruction to stop the defined set of hardware counters.

### FIELD OF THE INVENTION

The present invention relates generally to the data processing field, and more particularly, relates to a method, apparatus and computer program product for implementing breakpoint based performance measurement.

### DESCRIPTION OF THE RELATED ART

In software and compiler development, it is often needed to determine the amount of time needed to execute some function. It is also of interest to determine how often various hardware functions are executed within this function. A common technique currently used to measure the time during a function is to request a time stamp both before and after the function and subtract the two in order to determine the elapsed time. With the use of time stamps merely asking for the start and end times takes time, which can effect the results. Similarly, during the processing of the request for counts of other hardware functions results in those same hardware functions continuing to occur during the requests, which also can effect the results.

Ideally, the timing and counting of hardware functions would be limited to only the function being tested. One possible solution is to repetitively execute the function in an attempt to amortize the measurement cost over the entire period of the test. A problem with this measurement technique, however, is the time required for repetitively executing the function.

A need exists for an improved mechanism for implementing performance measurement.

### SUMMARY OF THE INVENTION

A principal object of the present invention is to provide a method, apparatus and computer program product for implementing breakpoint based performance measurement. Other important objects of the present invention are to provide such method, apparatus and computer program product for implementing breakpoint based performance measurement substantially without negative effect and that overcome many of the disadvantages of prior art arrangements.

In brief, a method, apparatus and computer program product are provided for implementing breakpoint based performance measurement. A set of hardware counters is defined for counting user specified hardware events. The hardware counters are programmable for counting predefined processor events and the predefined processor events includes processor cycles. A start breakpoint instruction and a stop breakpoint instruction are inserted in hardware instructions. The hardware instructions are executed and processing of the hardware instructions is suspended responsive to executing the start breakpoint instruction. Responsive to executing the start breakpoint instruction, interrupt handler instructions are entered and breakpoint instructions are called. The breakpoint instructions generating a return from interrupt instruction to start the defined set of hardware counters and to return processing from the interrupt handler instructions to the hardware instructions. Then executing the hardware instructions is suspended responsive to executing the end breakpoint instruction to stop the defined set of hardware counters.

### BRIEF DESCRIPTION OF THE DRAWINGS

The present invention together with the above and other objects and advantages may best be understood from the following detailed description of the preferred embodiment of the invention illustrated in the drawings, wherein:

FIGS. 1A and 1B are block diagram representations illustrating a computer system and operating system for implementing breakpoint based performance measurement in accordance with the preferred embodiment;

FIG. 2 is a logical flow diagram illustrating an exemplary implementation for breakpoint based performance measurement in accordance with the preferred embodiment; and

FIG. 3 is a block diagram illustrating a computer program product in accordance with the preferred embodiment.

### DETAILED DESCRIPTION OF THE PREFERRED EMBODIMENT

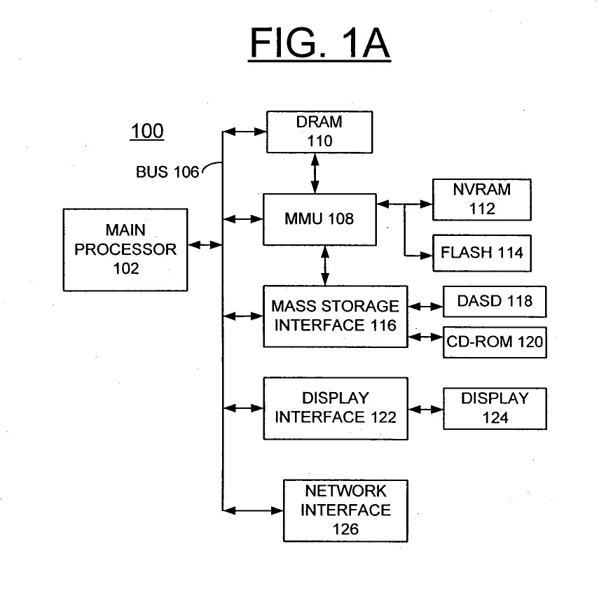

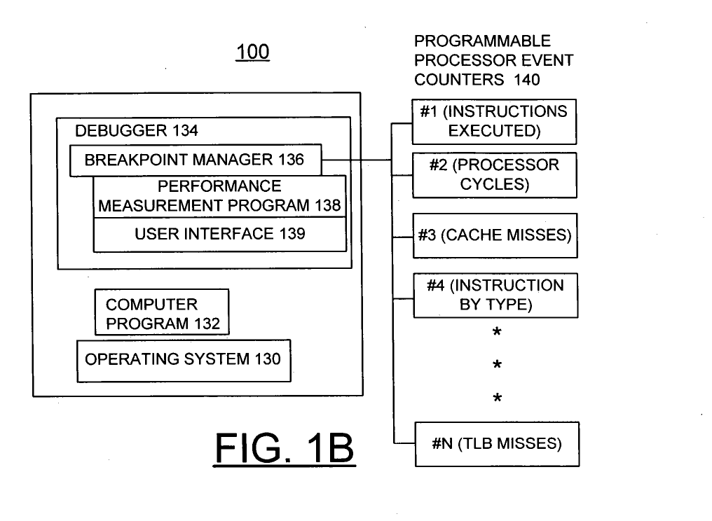

Referring now to the drawings, in FIGS. 1A and 1B there is shown a computer system generally designated by the reference character 100 for implementing breakpoint based performance measurement in accordance with the preferred embodiment. Computer system 100 includes a main processor 102 or central processor unit (CPU) 102 coupled by a system bus 106 to a memory management unit (MMU) 108 and system memory including a dynamic random access memory (DRAM) 110, a nonvolatile random access memory (NVRAM) 112, and a flash memory 114. The system bus 106 may be private or public, and it should be understood that the present invention is not limited to a particular bus topology used. A mass storage interface 116 coupled to the system bus 106 and MMU 108 connects a direct access storage device (DASD) 118 and a CD-ROM drive 120 to the main processor 102. Computer system 100 includes a display interface 122 connected to a display 124, and a network interface 126 coupled to the system bus 106.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, multiple main processors.

As shown in FIG. 1B, computer system 100 includes an operating system 130, a computer program 132, and a source level debugger 134 including a breakpoint manager 136, a performance measurement program 138 of the preferred embodiment, and a user interface 139. A plurality of programmable processor event counters 140, #1-#N are coupled to and operatively controlled by the breakpoint manager 136 with the performance measurement program 138 in accordance with the preferred embodiment. The programmable processor event counters 140, #1-#N in some embodiments are included in processor 102 and are programmable to count various types of events recognized by the processor 102.

A common debugging technique for the debugger 134 is used to install breakpoints into code in order to allow for a function to cease processing at that breakpoint and present the state of the program at that point. The low level support for this breakpoint is essentially a hardware instruction resulting in an interrupt out of executing code and processing being routed to the debugger. When the tool user decides to continue processing, the debugger arranges for the instruction overlaid by the breakpoint instruction to be executed and then executes a return from interrupt instruction in order to return to the processing of the interrupted function. Processing continues until the next breakpoint instruction is executed.

Events that can be counted by the programmable processor event counters 140, #1-#N include, for example, a number of instructions executed, a number of processor cycles spent executing a function (i.e., amount of time), a number of cache misses, a number of particular type of instructions (e.g. conditional branch instructions), a number of translation lookaside buffer (TLB) misses, and the like. Coupled with their capability of producing a processor interrupt when the programmable processor event counters 140 overflow, the programmable processor event counters 140 are typically used to provide a profile of how various software components of the operating system use the processor 102. In this mode the programmable processor event counters 140 tend to be free running and independent of a task, also known as a thread, or program that is executing. Typically, such as in the Power PC AS processor, the number of counters 140 is far less than the number of types of events that can be counted. For this reason, counters 140 are programmable for the type of performance analysis required.

In accordance with features of the preferred embodiment, a method is provided to determine the performance characteristics of a single call flow executed by a single task, rather than counting events within the overall operating system. The instructions within the single call flow are bounded to describe the period over which the programmable processor event counters 140 are incremented. The programmable processor event counters 140 start counting immediately at the beginning of this bounded call flow and stop counting immediately at the end of the bounded call flow. The bounds of the call flow are provided at arbitrary locations within the instruction stream.

In accordance with features of the preferred embodiment, the source level debugger 134 is used to define bounds within an instruction stream. The debugging tool's breakpoint support is used in presenting an elapsed time over an operation or function executed between two breakpoints. Along with timing of a particular function, it is also useful to be able to count selected programmable events during the execution of a function with the breakpoint manager 136 and performance measurement program 138 in accordance with the preferred embodiment. The value in a breakpoint instruction in accordance with the preferred embodiment essentially selects which of the possible types of events are to be counted with the programmable processor event counters 140.

Various commercially available computers can be used for computer system 100; for example, an iSeries computer system manufactured and sold by International Business Machines Corporation and processor 102 can be implemented, for example, by one of a line of PowerPC processors manufactured and sold by International Business Machines Corporation.

Processor 102, such as a PowerPC processor and various other processors, support multiple programmable counters 140, where sets of these counters can count various types of events in the hardware ranging from cycles, to instructions, to cache misses, to execution of various classes of instructions.

In accordance with features of the preferred embodiment, with hardware counter support, this debugger breakpoint tool becomes even more useful by limiting the measurement to strictly the function between the breakpoints. The measurement is limited only the code that executes between the breakpoints. This is from the moment that the code begins execution to the moment that the next breakpoint interrupt occurs.

Without it there is a fair amount of overhead outside of this measured code. This overhead further implies that the length of the performance run needs to be large enough so that the overhead becomes inconsequential. For instance, the best that we can do to measure a snippet of code is to materialize the time-of-day in the code both before and after the snippet. But even this takes some considerable time.

In accordance with features of the preferred embodiment, two instructions, an end breakpoint instruction and a start processing instruction, are used. The end breakpoint instruction is used that has the effect of interrupting and shutting down or freezing a set of selected counters 140. This function of this instruction is used at the end of a measured period. Prior to the beginning of the measured period a similar start breakpoint instruction informs the breakpoint manager 136 of the types of counters 140 to be included within the measured period via encode bits of the instructions.

In accordance with features of the preferred embodiment, a set of bits in the first breakpoint instruction can be used to define for the breakpoint manager 136 not for the hardware, a set of hardware counters 140 which are to be used to count hardware events, such as execution cycles (i.e. time). The breakpoint manager 136 identifies for the hardware those counters 140 that are to be used, initializes those counters 140, and indicates to the hardware that counting will begin with a trigger event. The trigger event here is really the execution of the start processing instruction. The counters would continue until processing reaches the next breakpoint instruction. The breakpoint manager 136 interrogates the previously programmed counters 140, save them for subsequent performance analysis. If the breakpoint instruction indicates that the counters should again be used, it starts the process over again. If the breakpoint instruction indicates that no counters are to be used, this process has effectively ended.

The start processing instruction is a return-from-interrupt instruction that starts the selected counters 140 enabled by the breakpoint manager 136 as specified in the preceding breakpoint instruction. The start processing or return-from-interrupt instruction is the last instruction of the breakpoint manager 136 and the first instruction of the code to be measured. For example, in the PowerPC AS architecture, these instructions can be provided by using some of the currently unused encodes of the existing system call/system call vectored (SC/SCV) and return from interrupt and return from system call vectored (RFID/RFSCV) instructions. With this enhanced support, the user is aware of other performance perturbing effects, such as, page faults, TLB misses, and cache misses, and that a task switch had occurred during the measurement period from the selected counters 140 enabled by the breakpoint manager 136.

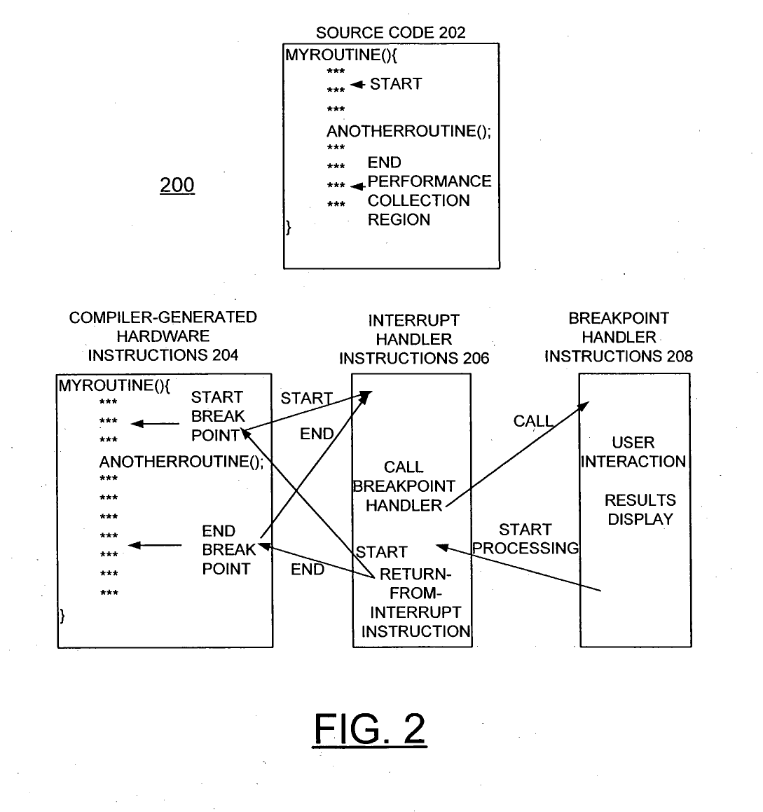

Referring now to FIG. 2 there is shown an exemplary logical implementation generally designated by the reference character 200 for breakpoint based performance measurement in accordance with the preferred embodiment. A user of the source level debugger 134 defines locations in the instruction stream as shown by start and end of a performance collection region in a source code 202 where the source level debugger 134 temporarily installs.

Compiler-generated hardware instructions 204 define breakpoint instructions within the instruction stream. Upon execution of a program, processing of that program is temporarily suspended when the breakpoint instruction is executed. The reason that program is temporarily suspended is that the breakpoint instruction produces a processor interrupt. An interrupt saves the processor state at the point of the breakpoint, enters a completely separate instruction stream of interrupt handler instructions 206 at the location of an interrupt handler, as indicated at a line labeled START from the compiler-generated instructions 204 to the interrupt handler instructions 206, and ultimately enters the code of breakpoint handler instructions 208 associated with a breakpoint handler, as indicated at a line labeled CALL.

In accordance with features of the preferred embodiment, this code or breakpoint handler instructions 208 allows the user of the debugger 134 to interrogate the program state and most importantly allows the user to request a return to program processing. The breakpoint handler does this by ultimately executing a single instruction indicated at a line labeled START PROCESSING that returns processing out of the interrupt handler and into the program again, immediately after the point of the first breakpoint interrupt, as indicated at a line labeled START RETURN-FROM-INTERRUPT INSTRUCTION from interrupt handler instructions 206 to the compiler-generated instructions 204. The reason this is important to the breakpoint performance measurement method of the preferred embodiment is that at this point in time, the initialized programmable hardware counters 140 are enabled to begin counting. It is this point in time that defines the beginning of the bounded instruction stream. Now the user's program is executing, calling arbitrary routines, using arbitrary processor facilities, and counting arbitrary processor events. At some point in time execution reaches the ending bound of the measurement period.

In accordance with features of the preferred embodiment, this ending bound is also defined by an interrupt due to the execution of a breakpoint instruction, again optionally installed by the source level debugger, labeled BREAKPOINT in the compiler-generated hardware instructions 204. It is at this point in time that the programmable hardware counters 140 stop counting. It is at exactly this point in time, not at some point later within the execution of the breakpoint handler. Doing otherwise would result in the counting of some unknown number of events outside of the function being measured. Although possible, creating a tool that counts events, and this includes time, outside of the measurement period would decrease the usefulness of the tool. It is the coupling of these performance counters 140 with the precision of starting and stopping of the counters 140 via interrupt-state transitioning instructions that is the core of the breakpoint performance measurement method of the preferred embodiment.

In addition to simply starting and stopping the counters, the user is able to specify, via the debugger breakpoint manager 136 including the performance measurement program 138 and user interface 139, that the arbitrary instruction stream is bounded in this way and to specify the types of events that the counters should count. Along with specifying via the source level debugger 134 the bounds of the measurement period, the user also specifies the type of events to be counted. An encoded version of this information can be carried in the breakpoint instruction 204 representing the beginning of the measurement period. An alternative would be for the debugger to record this information and the task ID on the user's thread prior to executing the breakpoint instruction 204 starting the measurement period. One straightforward way of doing this would be to first define the bounds, start the program to execute the time of the first of the breakpoints, and then have the debugger request the needed information.

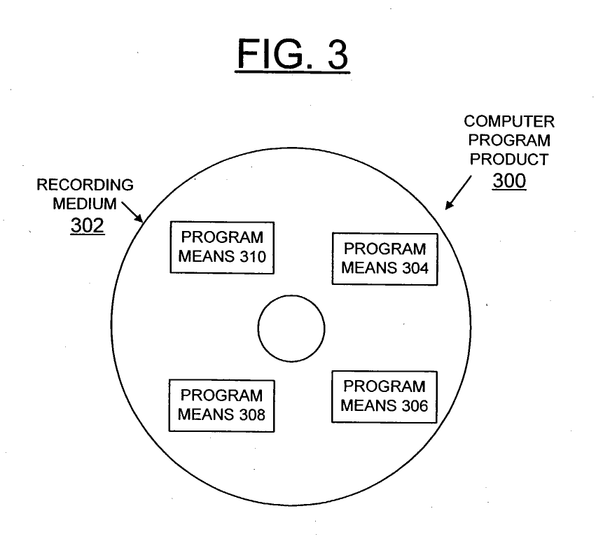

Referring now to FIG. 3, an article of manufacture or a computer program product 300 of the invention is illustrated. The computer program product 300 includes a recording medium 302, such as, a floppy disk, a high capacity read only memory in the form of an optically read compact disk or CD-ROM, a tape, a transmission type media such as a digital or analog communications link, or a similar computer program product. Recording medium 302 stores program means 304, 306, 308, 310 on the medium 302 for carrying out the methods for implementing breakpoint based performance measurement of the preferred embodiment in the system 100 of FIGS. 1A and 1B.

A sequence of program instructions or a logical assembly of one or more interrelated modules defined by the recorded program means 304, 306, 308, 310, direct the computer system 100 for implementing breakpoint based performance measurement of the preferred embodiment.

While the present invention has been described with reference to the details of the embodiment of the invention shown in the drawing, these details are not intended to limit the scope of the invention as claimed in the appended claims.

1. A method for implementing breakpoint based performance measurement using a set of hardware counters for counting hardware events; said hardware counters being programmable for counting predefined processor events; said predefined processor events including processor cycles; said method comprising:
inserting a start breakpoint instruction and a stop breakpoint instruction in hardware instructions;
executing said hardware instructions and suspending processing of said hardware instructions responsive to executing said start breakpoint instruction;
responsive to executing said start breakpoint instruction generating a processor interrupt for entering interrupt handler instructions and calling breakpoint instructions;
said breakpoint instructions generating a start processing instruction to return processing from said interrupt handler instructions to the hardware instructions and to start said defined set of hardware counters; and
executing the hardware instructions and suspending processing of the hardware instructions responsive to executing said end breakpoint instruction to stop said defined set of hardware counters.

2. A method for implementing breakpoint based performance measurement as recited in claim 1 wherein said predefined processor events include at least one of processor instructions executed, cache misses, a defined type of processor instruction executed, and translation lookaside buffer misses.

3. A method for implementing breakpoint based performance measurement as recited in claim 1 wherein a user specifies, via a debugger breakpoint manager including a performance measurement program and a user interface, a start bound and an end bound of a performance collection region of a user source code and said set of hardware counters.

4. A method for implementing breakpoint based performance measurement as recited in claim 1 wherein the inserting step includes inserting said start breakpoint instruction and said stop breakpoint instruction at arbitrary user defined locations in said hardware instructions.

5. A method for implementing breakpoint based performance measurement as recited in claim 1 includes the steps of enabling a user to interrogate a program state and to request said start processing instruction.

6. Apparatus for implementing breakpoint based performance measurement comprising:
a plurality of hardware counters for counting hardware events; said hardware counters being programmable for counting predefined processor events; said predefined processor events including processor cycles;
a source level debugger including a breakpoint manager;
said breakpoint manager including a performance measurement program and a user interface;
said breakpoint manager utilizing said performance measurement program and said user interface for defining a set of said hardware counters for counting user specified hardware events and for inserting a start breakpoint instruction and a stop breakpoint instruction in hardware instructions;
user program means for executing said hardware instructions and suspending processing of the hardware instructions responsive to executing said start breakpoint instruction and generating a processor interrupt for entering interrupt handler instructions and for calling said breakpoint manager;
said breakpoint manager for generating a start processing instruction to return processing from said interrupt handler instructions to the hardware instructions and to start said defined set of hardware counters; and
said user program means for executing the hardware instructions and suspending processing of the hardware instructions responsive to executing said end breakpoint instruction to stop said defined set of hardware counters

7. Apparatus for implementing breakpoint based performance measurement as recited in claim 6 wherein start breakpoint instruction includes encoded information specifying said defined set of hardware counters.

8. Apparatus for implementing breakpoint based performance measurement as recited in claim 6 wherein said breakpoint manager, responsive to said start breakpoint instruction, records user information specifying said defined set of hardware counters.

9. Apparatus for implementing breakpoint based performance measurement as recited in claim 6 wherein said predefined processor events further include at least one of processor instructions executed, cache misses, a defined type of processor instruction executed, and translation lookaside buffer misses.

10. Apparatus for implementing breakpoint based performance measurement as recited in claim 6 wherein said breakpoint manager inserts said start breakpoint instruction and said stop breakpoint instruction at arbitrary user defined locations in said hardware instructions.

11. A computer program product for implementing breakpoint based performance measurement in a computer system, said computer program product including instructions executed by the computer system to cause the computer system to perform the steps of:
defining a set of hardware counters for counting hardware events; said hardware counters being programmable for counting predefined processor events; said predefined processor events including processor cycles;
inserting a start breakpoint instruction and a stop breakpoint instruction in hardware instructions;
executing said hardware instructions and suspending processing of said hardware instructions responsive to executing said start breakpoint instruction;
responsive to executing said start breakpoint instruction generating a processor interrupt for entering interrupt handler instructions and calling breakpoint instructions;
said breakpoint instructions generating a start processing instruction to return processing from said interrupt handler instructions to the hardware instructions and to start said defined set of hardware counters; and
executing the hardware instructions and suspending processing of the hardware instructions responsive to executing said end breakpoint instruction to stop said defined set of hardware counters.

12. A computer program product for implementing breakpoint based performance measurement as recited in claim 11 includes the step of receiving user selections for a start bound and an end bound of a performance collection region of a user source code program and said set of hardware counters.

13. A computer program product for implementing breakpoint based performance measurement as recited in claim 11 wherein the inserting step includes inserting said start breakpoint instruction and said stop breakpoint instruction at arbitrary user defined locations in said hardware instructions.

14. A computer program product for implementing breakpoint based performance measurement as recited in claim 11 wherein said predefined processor events include at least one of processor instructions executed, cache misses, a defined type of processor instruction executed, and translation lookaside buffer misses.
